(19) United States
(12) Patent Application Publication
(10) Pub. No.: US 2013/0006997 A1
(43) Pub. Date: Jan. 3, 2013

(54) INFORMATION PROCESSING APPARATUS, CLIENT MANAGEMENT METHOD AND CLIENT MANAGEMENT SYSTEM

(76) Inventor: Atsushi Asayama, Tokyo (JP)

(21) Appl. No.: 13/410,023

(22) Filed: Mar. 1, 2012

(30) Foreign Application Priority Data
Jun. 30, 2011 (JP) 2011-145956

(51) Int. Cl. G06F 17/30

(52) U.S. Cl. 707/740; 707/741; 707/E17.032; 707/E17.083; 707/E17.089

(57) ABSTRACT

According to one embodiment, an information processing apparatus includes a storage, a log receiver and a merge module. The storage stores a plurality of log data, and first index data corresponding to the plurality of log data. The log receiver receives first log data and second index data from a client apparatus connected via a network, the second index data corresponding to the first log data. The merge module generates third index data by merging the first index data and the second index data. The storage stores the plurality of log data, the first log data and the third index data.

### CROSS-REFERENCE TO RELATED APPLICATIONS

This application is based upon and claims the benefit of priority from prior Japanese Patent Application No. 2011-145956, filed Jun. 30, 2011, the entire contents of which are incorporated herein by reference.

### FIELD

Embodiments described herein relate generally to an information processing apparatus which manages a client, a client management method which is applied to the apparatus, and a client management system.

### BACKGROUND

In a client-server system in which a client and a server are interconnected, a log indicative of a record of processes and operations in the client is, in some cases, managed by the server. The server can detect an unlawful operation in the client and can deal with a trouble, etc. occurring in the system, for example, by searching the log of the client.

In general, the server is interconnected to a plurality of clients. While these clients are being used, the logs of the clients are accumulated in the server. Thus, the amount of data that is managed by the server becomes enormous. Consequently, the time needed to retrieve a necessary log from the accumulated logs becomes longer.

At the time of retrieving a log including a specific character string from the accumulated logs, the server searches the logs by, for example, an index method. In the index method, indexes corresponding to the logs are created in advance. By making use of the indexes, the logs can quickly be searched, and therefore a necessary log can quickly be found out from the accumulated logs.

However, when index data corresponding to an enormous amount of data is created, the time needed for this process may possibly become longer. In this case, a search for log data cannot be executed until the index data is created. Thus, such a use as to search the collected log data in real time is difficult.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary conceptual view illustrating an example of the configuration of a client management system.

FIG. 2 is an exemplary conceptual view for describing a client management system according to an embodiment.

FIG. 3 is an exemplary block diagram illustrating an example of the configuration of the client management system of the embodiment.

FIG. 4 is an exemplary view illustrating a configuration example of policy data which is used by the client management system of the embodiment.

FIG. 5 is an exemplary view illustrating a configuration example of client inventory data which is used by the client management system of the embodiment.

FIG. 6 is an exemplary view illustrating an example of file index data included in temporary index data which is used by the client management system of the embodiment.

FIG. 7 is an exemplary view illustrating an example of word index data included in the temporary index data which is used by the client management system of the embodiment.

FIG. 8 is an exemplary view illustrating an example of file index data included in index data which is used by the client management system of the embodiment.

FIG. 9 is an exemplary view illustrating an example of word index data included in the index data which is used by the client management system of the embodiment.

FIG. 10 is an exemplary view illustrating an example of a policy setup screen which is displayed by the client management system of the embodiment.

FIG. 11 is an exemplary conceptual view for describing the flow of a process by the client management system of the embodiment.

FIG. 12 is an exemplary flowchart illustrating an example of the procedure of a server log management process which is executed by a server apparatus included in the client management system of the embodiment.

FIG. 13 is an exemplary flowchart illustrating an example of the procedure of a client log management process which is executed by a client apparatus included in the client management system of the embodiment.

FIG. 14 is an exemplary block diagram illustrating an example of the system configuration of the client apparatus included in the client management system of the embodiment.

FIG. 15 is an exemplary block diagram illustrating an example of the system configuration of the server apparatus included in the client management system of the embodiment.

### DETAILED DESCRIPTION

Various embodiments will be described hereinafter with reference to the accompanying drawings.

In general, according to one embodiment, an information processing apparatus includes a storage, a log receiver and a merge module. The storage stores a plurality of log data, and first index data corresponding to the plurality of log data. The log receiver receives first log data and second index data from a client apparatus connected via a network, the second index data corresponding to the first log data. The merge module generates third index data by merging the first index data and the second index data. The storage stores the plurality of log data, the first log data and the third index data.

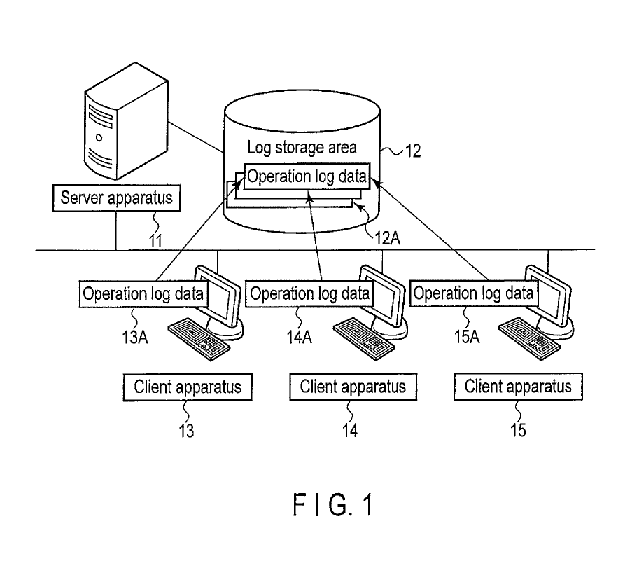

To begin with, referring to FIG. 1, an example of the configuration of a client management system is described. In the client management system, a server apparatus 11 and one or more client apparatuses 13, 14 and 15 are interconnected via a network. In this client management system, operation log data 13A, 14A and 15A of the client apparatuses 13, 14 and 15 are collected in the server apparatus 11.

Specifically, the client apparatus 13, 14, 15 generates operation log data 13A, 14A, 15A, which is indicative of an operation using the client apparatus 13, 14, 15, and transmits the operation log data 13A, 14A, 15A to the server apparatus 11 via the network. The server apparatus 11 stores the operation log data 13A, 14A, 15A, which has been transmitted by the client apparatus 13, 14, 15, in a log storage area 12 in a storage device. A plurality of operation log data 12A are stored in the log storage area 12. The server apparatus 11 manages the client apparatuses 13, 14 and 15 by using the operation log data 12A in the log storage area 12. For example, the server apparatus 11 detects an unlawful operation in the client apparatuses 13, 14 and 15 by searching the operation log data 12A, and then deal with a trouble, etc. occurring in the system.

The server apparatus 11 searches the operation log data 12A by, for example, a sequential search method or an index method. In the sequential search method, the server apparatus 11 sequentially scans text included in a plurality of operation log data 12A (e.g. plural document files), thereby detecting operation log data including a target character string (e.g. keyword). On the other hand, in the index method, the server apparatus 11 creates in advance index data corresponding to the plurality of operation log data 12A, and detects the operation log data including the target character string by using the index data. In the index method, by using the index data corresponding to the operation log data 12A, the operation log data including the target character string can be detected more quickly than in the sequential search method.

However, in some case, to generate the index data corresponding to the operation log data 13A, 14A and 15A, which are transmitted by the plural client apparatuses 13, 14 and 15, is a great load on the server apparatus 11. For example, when the number of client apparatuses which are connected to the server apparatus 11 is large, or when the data amount of the operation log data transmitted from the client apparatuses is large, a great deal of time is needed to generate the index data. In addition, for example, when a large-scale system in a cloud environment including several tens of thousands of client apparatuses is assumed, it is difficult for the server apparatus 11 to immediately generate index data corresponding to log data of all client apparatuses. Thus, the operation log data 12A stored in the server apparatus 11 cannot be used in real time after the storage.

Taking the above into account, the client management system of the present embodiment executes a two-stage process. In the two-stage process, for example, as regards log data belonging to a category designated by an administrator, log data belonging to a category with a high frequency of search, and log data belonging to a category with a large data amount (information amount), index data corresponding to the operation log data is generated in advance on the client apparatus side, and then the generated index data is integrated (merged) in the server apparatus. Specifically, since parts of the index data corresponding to the log data are generated in the client apparatuses, it should suffice if the server apparatus simply merges the generated index data. Thereby, the load on the server apparatus by the process of generating the index data can be reduced, and the time that is needed until the search of the operation log data with use of the index data is enabled can be shortened.

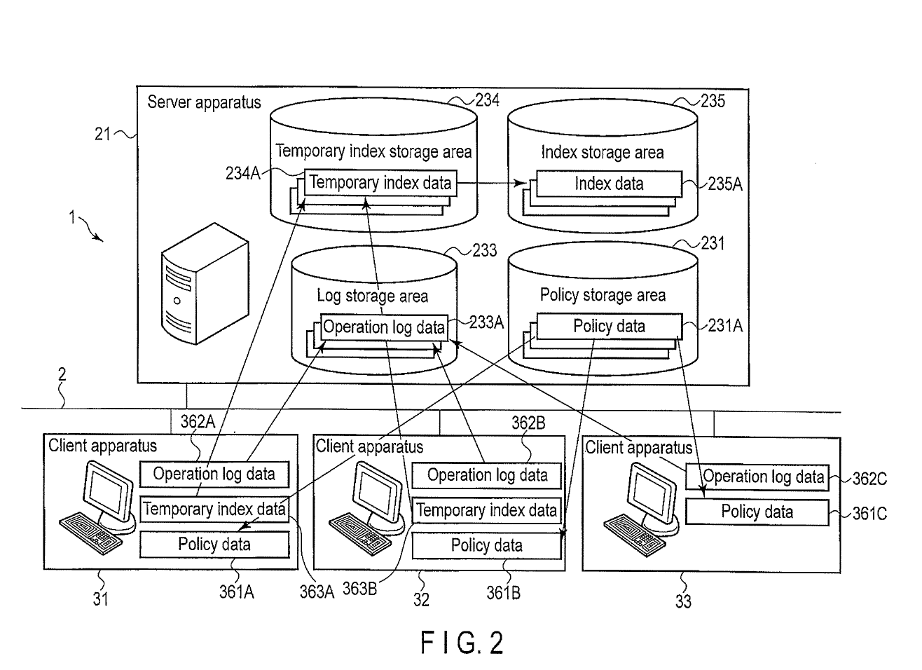

Referring to FIG. 2, an example of a client management system 1 according to an embodiment is described.

The client management system 1 is a client-server system in which a server apparatus 21 and one or more client apparatuses 31, 32 and 33 are interconnected via a network 2. The server apparatus 21 can be realized, for example, as a server computer. In addition, the client apparatus 31, 32, 33 can be realized as a personal computer. In the client management system 1, operation log data 362A, 362B and 362C of the client apparatuses 31, 32 and 33 are collected in the server apparatus 21. The server apparatus 21 can analyze the collected operation log data and obtain necessary log data (e.g. data including a keyword) from the collected operation log data.

To be more specific, the server apparatus 21 first delivers policy data of a plurality of policy data 231A to the client apparatuses 31, 32 and 33. The server apparatus 21 delivers the policy data which is respectively associated with the plural client apparatuses 31, 32 and 33.

The client apparatuses 31 and 32 collect the operation log data 362A and 362B, and generate temporary index data 363A and 363B corresponding to the operation log data 362A and 362B, based on policy data 361A and 361B delivered by the server apparatus 21. For example, the client apparatuses 31 and 32 generate temporary index data corresponding to operation log data belonging to a category designated in the policy data 361A, 361B, 361C, and do not generate temporary index data corresponding to operation log data belonging to other categories. In addition, for example, in the client apparatus 33, there is no operation log data belonging to the category designated in the policy data 361C. Thus, the client apparatus 33 does not generate temporary index data which corresponds to operation log data 362C (i.e. operation log data which does not belong to the designated category). Then, the client apparatuses 31, 32 and 33 transmit the operation log data 362A, 362B and 362C and temporary index data 363A and 363B to the server apparatus 21.

The server apparatus 21 stores the transmitted log data 362A, 362B and 3620 in a log storage area 233. In addition, the server apparatus 21 merges the transmitted temporary index data 363A and 363B into index data 235A which is stored in an index storage area 235. Further, the server apparatus 21 generates index data of, among the transmitted operation log data 362A, 362B and 362C, that operation log data, in association with which temporary index data 363A, 363B has not been generated. The server apparatus 21 stores the generated index data in the index storage area 235. Thereby, the server apparatus 21 can search operation log data 233A by making use of the index data 235A.

As has been described above, in association with the operation log data belonging to the category designated in the policy data 361A, 361B, 361C, the temporary index data 363A, 363B is generated in the client apparatus 31, 32. Thus, the server apparatus 21 does not need to perform the generation itself of the index data, and it should suffice if the server apparatus 21 merges the temporary index data 363A and 363B into the index data 235A. Therefore, the load of processing, which is necessary for the server apparatus 21 to obtain the index data 235A, can be reduced.

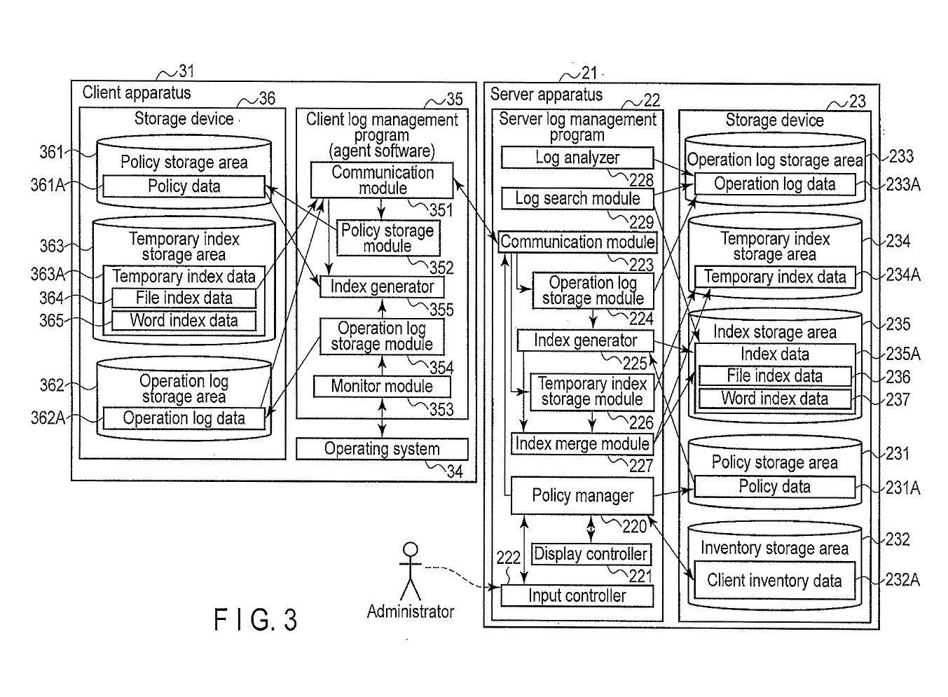

Next, referring to FIG. 3, the structure of the client management system 1 is described. The client management system 1 includes a server apparatus 21 and a client apparatus 31. The server apparatus 21 and client apparatus 31 are interconnected via, e.g. a network.

The server apparatus 21 executes a server log management program 22. The server log management program 22 is software including a function of managing log data which is transmitted by the client apparatus 31. The server log management program 22 includes a policy management function, a log management function and a log search function. The server log management program 22 includes a policy manager 220, a display controller 221, an input controller 222, a communication module 223, an operation log storage module 224, an index generator 225, a temporary index storage module 226, an index merge module 227, a log analyzer 228, and a log search module 229. In addition, the server log management program 22 stores data in a storage device 23 which is provided in the server apparatus 21, and executes processes by using the stored data. The storage device 23 includes a policy storage area 231, an inventory storage area 232, an operation log storage area 233, a temporary index storage area 234, and an index storage area 235.

The client apparatus 31 executes a client log management program 35. The client log management program 35 is agent software including a function of managing log data of the client apparatus 31. The client log management program 35 collects a log indicative of contents of operations of the client apparatus 31, and generates an index corresponding to the collected log. The client log management program 35 transmits the collected log and the generated index to the server apparatus 21. The client log management program 35 includes a communication module 351, a policy storage module 352, a monitor module 353, an operation log storage module 354, and an index generator 355. In addition, the client log management program 35 stores data in a storage device 36 which is provided in the client apparatus 31, and executes processes by using the stored data. The storage device 36 includes a policy storage area 361, an operation log storage area 362 and a temporary index storage area 363.

To begin with, the operations of the respective components by the policy management function of the server apparatus 21 are described.

The input controller 222 detects various kinds of inputs by the administrator. The inputs by the administrator are executed by using various kinds of input devices such as a keyboard, a mouse, a touch panel and a touchpad. To be more specific, the input controller 222 detects, for example, an input to instruct display of a policy setup screen, and an input to instruct determination of a policy. The policy setup screen is a screen for the administrator to setup a policy. Using the policy setup screen, the administrator can newly determine a policy which is associated with the client apparatus 31, or can change the policy which is already associated. In response to the detection of the input to instruct the display of the policy setup screen, the input controller 222 requests the display controller 221 to display the policy setup screen. In response to the detection of the input to instruct determination of a policy, the input controller 222 notifies the policy manager 220 that the policy has been determined.

The policy manager 220 manages policy data 231A stored in the policy storage area 231. The policy data 231A is indicative of a policy for causing the client apparatus 31 to generate index data (temporary index data). In response to the notification by the input controller 222, the policy manager 220 generates policy data 231A corresponding to the determined policy.

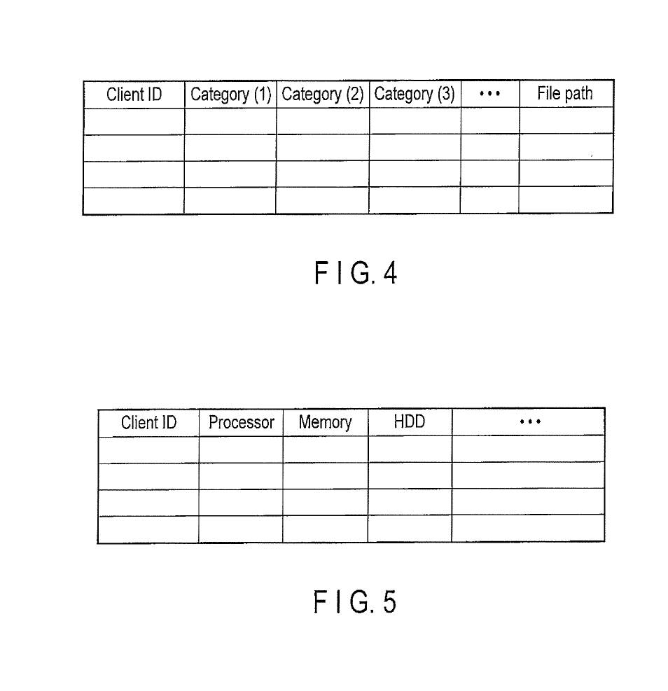

FIG. 4 illustrates a configuration example of the policy data 231A. The policy data 231A includes one or more entries corresponding to one or more client apparatuses 31. In other words, one entry is associated with one client apparatus 31. Each entry includes, for example, a client ID, a category and a file path. In the entry corresponding to a certain client apparatus, “Client ID” is indicative of identification information (also referred to as “identifier”) which is unique to this client apparatus. The “Client ID” is also used as a base ID for generating a file ID which is allocated to operation log data (log file) generated by this client apparatus. By using the identification information unique to the client apparatus as the base ID, the ID of the operation log data, which has been transmitted from the client apparatus, is prevented from colliding, on the server apparatus 21, with the ID of operation log data which has been transmitted by another client.

“Category” is indicative of a category of log data whose temporary index data is to be generated, among the log data collected by the client apparatus. The entry may include a plurality of “Categories”. Thus, in the client apparatus, temporary index data is generated in association with log data, among the collected log data, which belongs to the category designated in the entry corresponding to the client apparatus. In the meantime, the entry may not include “Category”. In this case, no temporary index data is generated in the client apparatus.

Values which are set in the “Category” are, for example, “Web”, “File”, “Mail”, “External device”, “Boot/shutdown”, and “Logon/logoff”. For example, if “Web” is set in “Category (1)” and “File” is set in “Category (2)”, temporary index data, which correspond to log data relating to a Web operation (e.g. an operation using a Web browser) and log data relating to a file operation (e.g. an operation of creation, delete, copy, move, or edit of a file), are generated in the client apparatus. In the “Category”, for example, a category to which log data with high frequency of search belongs, or a category to which log data with a large amount of collected data belongs, is set. With such categories being set, the load on the server apparatus 21 due to the generation of the index can be reduced.

“File path” is indicative of a path of a directory in the server apparatus 21, at which operation log data transmitted from the client apparatus is stored.

The policy manager 220 outputs the generated policy data 231A to the communication module 223. Specifically, the policy manager 220 outputs the entries of the policy data 231A to the communication module 223, so that the entries of the policy data 231A, which are associated with one or more client apparatuses 31, are transmitted to the one or more client apparatuses 31. The policy manager 220 executes such control as to deliver the policy data 231A to the client apparatus 31, for example, at predetermined time intervals, or when the policy has been updated.

The communication module 223 transmits the policy data 231A, which has been output by the policy manager 220, to the client apparatus 31 (communication module 351). Specifically, the communication module 223 transmits the entry of the policy data 231A, which has been output by the policy manager 220, to the client apparatus 31 with which the entry is associated. Since the category, for which index generation is executed in the client apparatus 31, is controlled by delivering the policy to the client apparatus 31, the load on the client apparatus 31 can be adjusted. For example, the load on the client apparatus 31 can be adjusted by generating an index which corresponds to not all the log data collected by the client apparatus 31 but a part of the log data (e.g. log data belonging to a category with a high frequency of search or a category with a large amount of data).

In the meantime, the policy manager 220 may generate the policy data 231A, based on client inventory data 232A stored in the inventory storage area 232. The client inventory data 232A includes values indicative of the capability (performance) of one or more client apparatuses 31.

FIG. 5 illustrates a configuration example of the client inventory data 232A. The client inventory data 232A includes one or more entries corresponding to one or more client apparatuses 31. Each entry includes, for example, a client ID, a processor, a memory, and an HDD. In the entry corresponding to a certain client apparatus, “Client ID” is indicative of identification information unique to the client apparatus. “Processor” is indicative of the processing speed (e.g. a processing speed in GHz) of a processor (CPU) which is provided in the client apparatus. “Memory” is indicative of a memory capacity (e.g. a memory capacity in GB) of a memory which is provided in the client apparatus. “HDD” is indicative of a memory capacity (e.g. a memory capacity in GB) of a hard disk drive (storage device) which is provided in the client apparatus.

By referring to the client inventory data 232A, the policy manager 220 can read values indicative of the capabilities of the client apparatuses 31 which are connected to the server apparatus 21. Based on the read values indicative of the capability of the client apparatus 31, the policy manager 220 determines the category of log data, whose temporary index data is to be generated in the client apparatus 31, among the log data collected in the client apparatus 31. For example, the client apparatus, in which the processing speed of the processor is equal to or greater than a first threshold, and the memory capacity of the memory is equal to or greater than a second threshold, is determined to have the capability of generating index data. Thus, the policy manager 220 creates the policy data 231A in which the “Category”, based on which this client apparatus is to generate index data, is set. In addition, for example, the client apparatus, in which the processing speed of the processor is lower than the first threshold, is determined not to have the capability of generating index data. Thus, the policy manager 220 creates the policy data 231A in which the “Category”, based on which this client apparatus is to generate index data, is not set. Incidentally, the policy manager 220 may create the policy data 231A, based on the number of client apparatuses which are connected to the server apparatus 21. For example, when the number of client apparatuses is equal to or greater than a third threshold, the policy manager 220 creates the policy data 231 so that index data may be generated in the client apparatus.

Next, the operations of the respective components in the client apparatus 31 are described.

The communication module 351 receives the policy data 231A which is associated with the client apparatus 31 and has been transmitted by the server apparatus 21 (communication module 223). The communication module 351 outputs the received policy data 231A to the policy storage module 352. In addition, the communication module 351 outputs the client ID (base ID) in the policy data 231A to the index generator 355. This base ID may be a base ID, which has been transmitted by the server apparatus 21, separately from the policy data 231A.

The policy storage module 352 stores the policy data 231A, which has been output by the communication module 351, in the policy storage area 361. Thereby, in the client apparatus 31, temporary index data 363A corresponding to the operation log data 362A is generated based on the policy data 361A (i.e. policy data 231A) stored in the policy storage area 361.

Next, the monitor module 353 detects an operation on the client apparatus 31, by monitoring an operating system 34 and various applications which are executed on the client apparatus 31. The monitor module 353 detects, for example, operations relating to the use of the Web, files, mails, and devices and the boot, shutdown, logon and logoff of the client apparatus 31. The monitor module 353 may detect not only operations by the user, but may also detect, for example, an operation by a program which is automatically executed at predetermined intervals (e.g. an inquiry to a mail server at predetermined intervals, or a periodical update of a security program). The monitor module 353 notifies the operation log storage module 354 that an operation on the client apparatus 31 has been detected.

In response to the notification by the monitor module 353, the operation log storage module 354 generates operation log data 362A indicative of the content of the detected operation, and then stores the operation log data 362A in the operation log storage area 362. The generated operation log data 362A is, for example, a file in which the date/time, category and the content of the operation are described. This file is a file of, e.g. a text format. A plurality of operation log data 362A (i.e. a plurality of text files) are stored in the operation log storage area 362. In addition, the operation log storage module 354 outputs the generated operation log data 362A to the index generator 355.

Specifically, when the detected operation is a Web operation, the content of the operation described in the operation log data 362A includes, for example, the title, URL, etc. of the Web page browsed by the Web operation. When the detection operation is a file operation, the content of the operation described in the operation log data 362A includes, for example, a file name, the kind of operation (copy, move, delete, create, edit, etc.). When the detected operation is a mail operation, the content of the operation described in the operation log data 362A includes, for example, a destination address, a sender address, the title of mail, the body of mail, an attachment file, etc. When the detected operation is the use of a device, the content of the operation described in the operation log data 362A includes, for example, the identification number of the device, the name of the device, the kind of the device, and the interface to which the device is connected.

The index generator 355 generates temporary index data 363A corresponding to the operation log data 362A which has been output by the operation log storage module 354. Specifically, the index generator 355 generates temporary index data 363A corresponding to first log data among the output operation log data 362A, the first log data belonging to a first category designated in the policy data 361A. This temporary index data 363A is also referred to as “second index data”. The temporary index data 363A includes file index data 364 and word index data 365.

Of the operation log data 362A, log data, which does not belong to the first category designated in the policy data 361A, is also referred to as “second log data”. Accordingly, the operation log data 362A includes the first log data which belongs to the first category, and the second log data which does not belong to the first category. Incidentally, when all data included in the, operation log data 362A belongs to the first category, the operation log data 362A includes the first log data alone. Meanwhile, when none of the data included in the operation log data 362A belongs to the first category, the operation log data 362A includes the second log data alone. In the meantime, the number of categories designated in the policy data 361A may be plural.

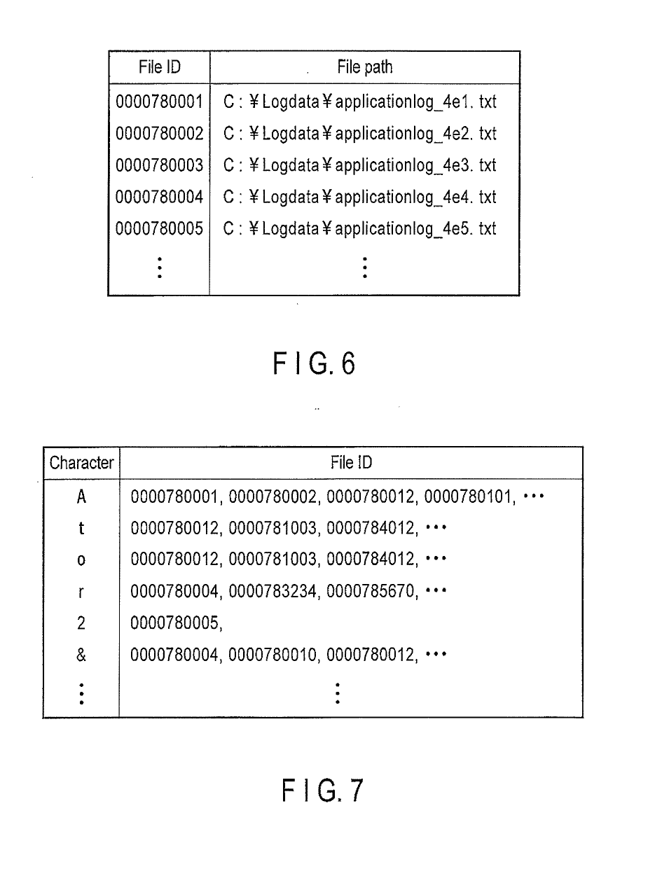

FIG. 6 shows an example of the file index data 364 included in the temporary index data 363A. The file index data 364 includes a plurality of entries corresponding to a plurality of log files. For example, when a plurality of operation log data 362A (a plurality of log files) are stored in the operation log storage area 362, the file index data 364 includes a plurality of entries. Each entry includes a file ID and a file path. In an entry corresponding to a certain log file, “File ID” is indicative of identification information unique to the log file. The value set in the “File ID” is, for example, a value that is generated by appending a sequential number, which is allocated to the log file, to a base ID (client ID) which has been transmitted in advance by the server apparatus 21. For example, when a new log file, to which a sequential number “0001” is allocated, has been created in the case in which the base ID “000078” has been transmitted by the server apparatus 21, a value “0000780001” is set in the “File ID” of the entry corresponding to this file.

“File path” is indicative of a file path which represents the location at which the log file is stored in the server apparatus 21. The path indicative of the directory, at which the log file is stored in the server apparatus 21, is indicated, for example, in the policy data 361A which is transmitted in advance to the client apparatus 31 by the server apparatus 21. The client apparatus 31 generates the value of the “File path” by appending the file name of the log file to the path indicative of the directory included in the policy data 361A. For example, when a new log file with a file name “applicationlog_{—}4el.txt” has been created in the case in which the path “C:Logdata\” of the directory is included in the policy data 361A, “C:\Logdata\applicationlog_{—}4el.txt” is set in the “File path” of the entry corresponding to this file.

FIG. 7 shows an example of the word index data 365 included in the temporary index data 363A. In the example shown in FIG. 7, it is assumed that the word index data 365 is created based on a unigram model (n-gram model, where n=1). The word index data 365 includes a plurality of entries corresponding to a plurality of characters. Each entry includes a character and a file ID. In an entry corresponding to a certain character, “Character” is indicative of the character itself. “File ID” is indicative of an ID of the file including the character. IDs of plural files may be set in the “File ID”. The word index data 365 includes entries corresponding to all characters included in the operation log data 362A (log file).

Specifically, as shown in FIG. 7, when a character string “r&” is included in a log file having the “File ID” of “0000780004”, “0000780004” is set in the “File ID” of an entry corresponding to character “r” and in the “File ID” of an entry corresponding to character “&”. Accordingly, by referring to the word index data 365, it is understood that, for example, files including character “r” are files with the file IDs “0000780004”, “0000783234” and “0000785670”.

When the operation log data (log file) 362A belongs to the category designated in the policy data 361A, the index generator 355 generates an entry of the file index data 364 and an entry of the word index data 365, which correspond to this log data. For example, when “Web” is designated in the “Category” of the policy data 361A, if the operation log data 362A indicative of a Web operation has been output, the index generator 355 generates an entry of the file index data 364 and an entry of the word index data 365, which correspond to this log data. For example, the index generator 355 generates entries of the word index data 365 including “Character”, into which the text included in the log data has been decomposed based on the n-gram model, and including “File ID”. Then, the index generator 355 stores (adds) the generated entries in the temporary index storage area 363. In the meantime, the word index data 365, which is generated by the index generator 355, is not limited to the word index data corresponding to characters obtained by the n-gram model, but may be word index data corresponding to words obtained by morphological analysis.

In addition, when “Web” is designated in the “Category” of the policy data 361A, if the operation log data 362A indicative of a mail operation has been output, the index generator 355 generates neither the entry of the file index data 364 nor the entry of the word index data 365, which corresponds to this log data.

Subsequently, the communication module 351 transmits the operation log data 362A and temporary index data 363A to the server apparatus 21 (communication module 223). For example, the communication module 351 transmits the operation log data 362A and temporary index data 363A to the server apparatus 21 at predetermined intervals (e.g. after the passing of a predetermined time since the previous transmission of the log). Incidentally, for example, when a predetermined amount of log data 362A has been accumulated in the operation log storage area 362, the communication module 351 may transmit the operation log data 362A and temporary index data 363A to the server apparatus 21.

Next, the operations of the respective components by the log management function of the server apparatus 21 are described.

The communication module 223 receives the temporary index data 363A (second index data) and operation log data 362A, which have been transmitted by the client apparatus 31 (communication module 351). As described above, the operation log data 362A may include the first log data belonging to the first category indicated in the policy data 361A, and the second log data not belonging to the first category. In addition, the second index data 363A corresponds to the first log data. The communication module 223 outputs the received temporary index data 363A to the temporary index storage module 226. The communication module 223 also outputs the received operation log data 362A to the operation log storage module 224.

The temporary index storage module 226 stores the temporary index data 363A, which has been output by the communication module 223, in the temporary index storage area 234. Then, the temporary index storage module 226 notifies the index merge module 227 that new temporary index data 234A (363A) has been stored in the temporary index storage area 234.

In response to the notification by the temporary index storage module 236, the index merge module 227 merges the temporary index data 234A, which is stored in the temporary index storage area 234, into the index data 235A stored in the index storage area 235. This index data 235A is first index data corresponding to the operation log data (plural log data) stored in the operation log storage area 233. Specifically, the index merge module 227 generates new index data in which the index data 235A (first index data) and temporary index data 234A (second index data) have been merged. This new index data is also referred to as “third index data”. The index merge module 227 stores the new index data (third index data) in the index storage area 235. To be more specific, the index merge module 227 merges the file index data and word index data, which are included in the temporary index data 234A, into the file index data 236 and word index data 237, which are included in the index data 235A, and then stores the merged index data in the index storage area 235. Incidentally, when neither data is stored in the index storage area 235 (e.g. in the initial state), the index merge module 227 stores the temporary index data 234A as such in the index storage area 235.

In addition, the operation log storage module 224 stores (adds) the operation log data 362A, which has been output by the communication module 223, in the operation log storage area 233. In the operation log storage area 233, the operation log data 233A (plural operation log data) may have already been stored. In this case, the operation log data 233A and the operation log data 362A (i.e. first log data and second log data) are stored in the operation log storage area 233. Then, the operation log storage module 224 notifies the index generator 225 that the new operation log data 233A (362A) has been added to the operation log storage area 233.

In response to the notification by the operation log storage module 224, the index generator 225 generates fourth index data which corresponds to, among the newly added operation log data 233A, the second log data, whose associated temporary index data 363A (second index data) has not been generated. Specifically, based on the entry of the policy data 231A corresponding to the client apparatus 31, the index generator 225 detects, among the operation log data 233A, the operation log data (second log data), whose associated temporary index data 234A is absent. Then, the index generator 225 generates the fourth index data corresponding to the detected second log data. The fourth index data includes file index data and word index data. The method of generating the fourth index data is the same as the method that has been described in connection with the index generator 355 of the client apparatus 31. The index generator 225 outputs the generated fourth index data (file index data and word index data) to the index merge module 227.

The index merge module 227 merges the fourth index data (file index data and word index data), which has been output by the index generator 225, into the index data 235A stored in the index storage area 235. In other words, the index merge module 227 generates the third index data in which the first index data corresponding to the plural operation log data 233A, the second index data corresponding to the first log data, and the fourth index data corresponding to the second log data, have been merged. The generated third index data is stored in the index storage area 235. Then, in response to the fact that the index data (second index data and fourth index data) corresponding to the operation log data 362A received from the client apparatus 31 has been stored (merged) in the index storage area 235, the index merge module 227 deletes the temporary index data 234A from the temporary index storage area 234.

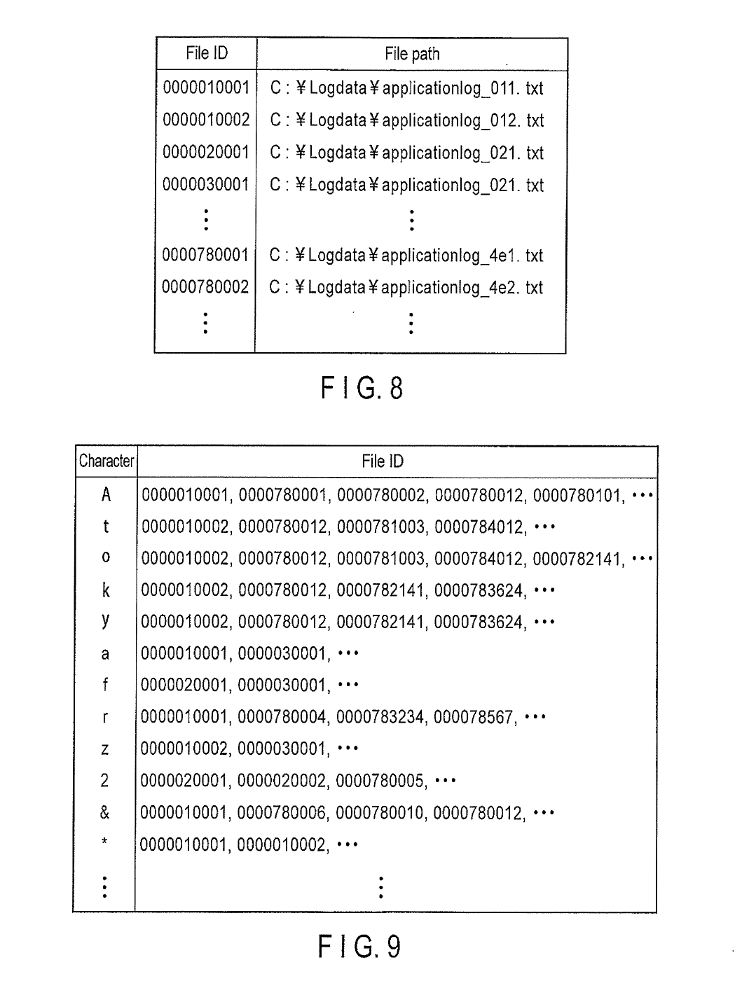

FIG. 8 shows an example of the file index data 236 included in the index data 235A. The configuration of the file index data 236 is the same as the file index data 364 which has been described with reference to FIG. 6. The file index data 236 includes, for example, data in which a plurality of file index data 364 transmitted by a plurality of client apparatuses have been merged. The file index data 236 also includes file index data which have been generated by the index generator 225 and merged by the index merge module 227. In the example shown in FIG. 8, the file index data 236 includes entries corresponding to log files which have been transmitted by client apparatuses with client IDs (base IDs) “000001”, “000002”, “000003” and “000078”.

FIG. 9 shows an example of the word index data 237 included in the index data 235A. The configuration of the word index data 237 is the same as the word index data 365 which has been described with reference to FIG. 7. The word index data 237 includes, for example, data in which a plurality of word index data 365 transmitted by a plurality of client apparatuses have been merged. The word index data 237 also includes word index data which have been generated by the index generator 225 and merged by the index merge module 227.

Next, the operations of the respective components by the log search function of the server apparatus 21 are described.

The log search module 229 searches the operation log data 233A by using the index data 235A. For example, the log search module 229 finds out, from the operation log data 233A, operation log data including a search character string (keyword) that has been input by the administrator (i.e. extracts a log file including a keyword). A search screen for the log search is displayed by, for example, the display controller 221. The administrator inputs a keyword, which is to be searched, to the displayed search screen. This keyword is output to the log search module 229 by, for example, the input controller 222.

For example, the case is now assumed that the operation log data 233A is searched by using the word index data 237 shown in FIG. 9, with a keyword “tokyo” being used. In this case, the log search module 229 first decomposes the keyword and detects characters “t”, “o”, “k”, and “y”. Using the word index data 237, the log search module 229 detects file IDs corresponding to these characters, respectively. Specifically, “0000010002”, “0000780012”, “0000781003” and “0000784012” which correspond to “t”, “0000010002”, “0000780012”, “0000781003”, “0000784012”, and “0000780012” which correspond to “o”, “0000010002”, “0000780012”, “0000782141” and “0000783624” which correspond to “k”, and “0000010002”, “0000780012”, “0000782141” and “0000783624” which correspond to “y” are detected. Then, the log search module 229 detects file IDs corresponding to all of these characters, from among the file IDs corresponding to the respective characters. Specifically, “0000010002” and “0000780012”, which correspond to all of “t”, “o”, “k”, and “y”, are detected. In other words, the log search module 229 detects the file IDs of log files including all characters in the keyword, by using the word index data 237. Then, using the file index data 237, the log search module 229 detects file paths corresponding to the detected file IDs, thereby reading log files corresponding to the detected file paths from the operation log storage area 233. The read log files (search result) are displayed, for example, on the screen by the display controller 221. Thereby, the administrator can access the log files (log data) including the keyword.

The log analyzer 228 analyzes the accumulated operation log data 233A. The log analyzer 228 analyzes, for example, categories, data amounts, a tendency such as the frequency of search, etc. of the operation log data 233A. The log analyzer 228 may analyze the operation log data 233 by using the index data 235A.

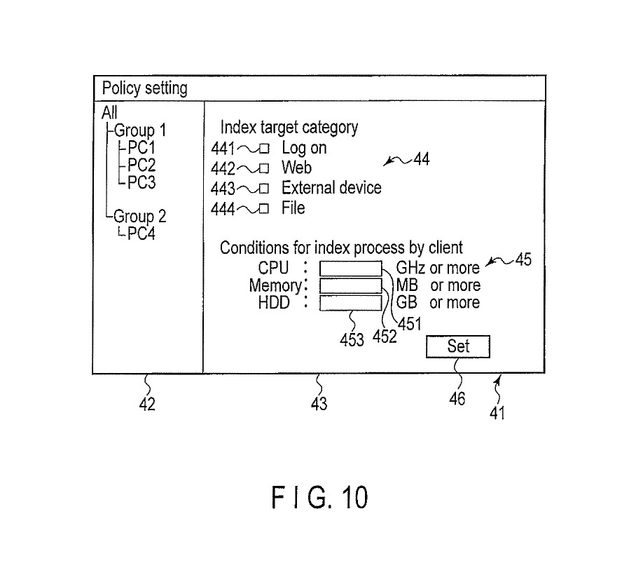

FIG. 10 shows an example of a policy setup screen 41 displayed by the server apparatus 21. In the example shown in FIG. 10, the policy setup screen 41 includes a client select area 42 and a policy setup area 43. In the client select area 42, a plurality of client apparatuses, which are connected to the server apparatus 21, are indicated, for example, in a hierarchical structure. The items indicated in the hierarchical structure are selectably displayed. Thus, by selecting items indicated in the hierarchical structure, the user can select target client apparatuses for which the policy is to be set up. For example, “All” is selected, the policy, which is associated with all client apparatuses, can be set up. When “Group 1” is selected, the policy, which is associated with the client apparatuses (PC1, PC2 and PC3) belonging to Group 1, can be set up.

The policy setup area 43 includes an index target category select area 44 and an index process condition input area 45. The index target category select area 44 includes check boxes for selecting a target category, in connection with which the temporary index data 363A is to be generated. The check boxes include, for example, “Logon” 441, “Web” 442, “External device” 443, and “File” 444. Using the check boxes 441, 442, 443 and 444, the user can select the target category, in connection with which the temporary index data 363A is to be generated.

The index process condition input area 45 includes an input area for inputting conditions under which the temporary index data 363A is to be generated by the client apparatus, and a “Setup” button 46. This input area includes, for example, a “CPU” area 451, a “Memory” area 452, and an “HDD” area 453. Using these input areas 451, 452 and 453, the user can input the conditions under which the temporary index data 363A is to be generated by the client apparatus.

The “Setup” button 46 is a button for setting up the selected index target category and index process conditions. Specifically, in response to the pressing of the “Setup” button, the policy manager 220 generates (updates) the policy data 231A. Accordingly, when the conditions, which have been input to these input areas 451, 452 and 453, are satisfied (i.e. when the client apparatus satisfies the capabilities which have been input), the client apparatus generates the temporary index data 363A corresponding to the operation log data 362A.

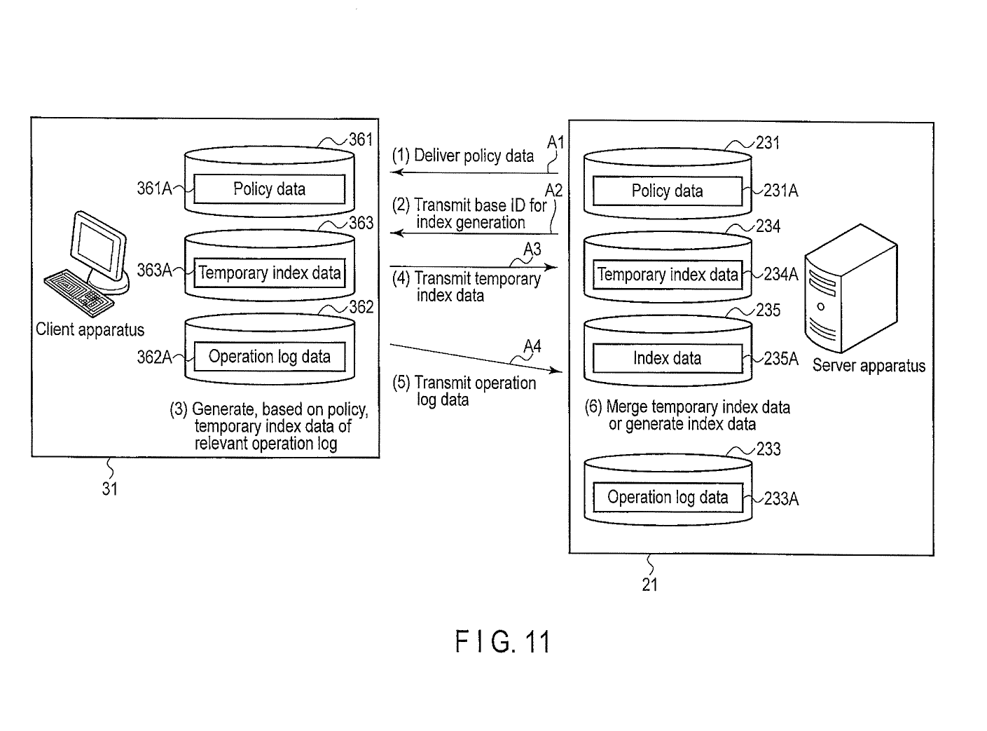

Next, referring to FIG. 11, a description is given of the data flow in the client management system 1.

To start with, the server apparatus 21 delivers policy data 231A to the client apparatus 31 (A1). The client apparatus 31 stores the delivered policy data 231A in the policy storage area 361.

Then, the server apparatus 21 transmits a base ID to the client apparatus 31 (A2). The base ID is identification information for the client apparatus 31 to generate temporary index data 363A. Based on the policy data 361A stored in the policy storage area 361, the client apparatus 31 generates, with use of the base ID, the temporary index data 363A corresponding to the operation log data 362A.

Subsequently, the client apparatus 31 transmits the generated temporary index data 363A to the server apparatus 21 (A3). The server apparatus 21 stores the transmitted temporary index data 363A in the temporary index storage area 234. In addition, the client apparatus 31 transmits the operation log data 362A, which is stored in the operation log storage area 362, to the server apparatus 21 (A4). The server apparatus 21 stores the transmitted operation log data 362A in the operation log data storage area 233.

Following the above, the server apparatus 21 merges the temporary index data 234A, which is stored in the temporary index storage area 234, into the index data 235A. In addition, based on the policy data 231A, the server apparatus 21 detects, among the operation log data 362A transmitted by the client apparatus 31, operation log data whose associated temporary index data 234A (363A) is absent. Then, the server apparatus 21 generates index data corresponding to the detected operation log data (i.e. adds the index data to the index data 235A stored in the index storage area 235).

By the above-described data flow, the server apparatus 21 acquires the operation log data 233A of the client apparatus 31 and the index data 235A corresponding to this operation log data 233A. The server apparatus 21 can easily search the operation log data 233A by using the index data 235A. In addition, since the temporary index data 363A is generated in the client apparatus 31, the server apparatus 21 does not need to perform the generation itself of the index data, and it should suffice if the server apparatus 21 merges the temporary index data 363A into the index data 235A. Therefore, the load of processing, which is necessary for the server apparatus 21 to obtain the index data 235A, can be reduced.

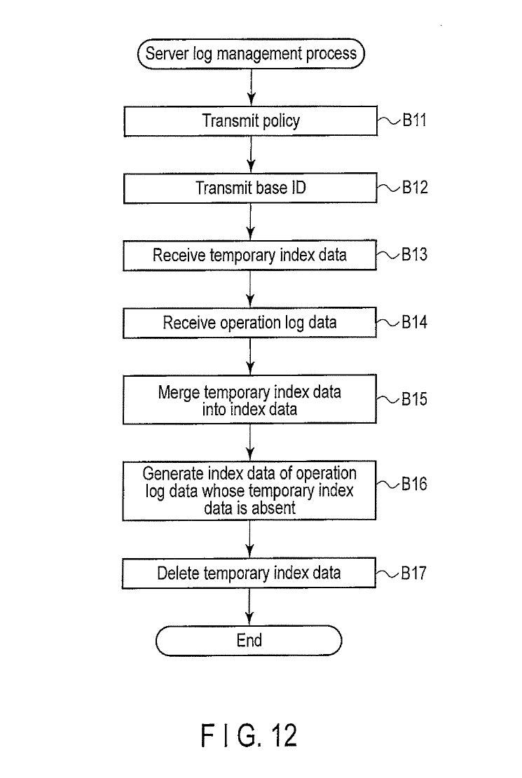

Next, referring to a flowchart of FIG. 12, a description is given of an example of the procedure of a log management process by the server apparatus 21.

To start with, the policy manager 220 transmits policy data 231A to the client apparatus 31 via the communication module 223 (block B11). Specifically, the policy manager 220 reads the policy data 231A, which is associated with the client apparatus 31, from the policy storage area 231. The policy manager 220 outputs the read policy data 231A to the communication module 223. Then, the communication module 223 transmits the policy data 231A to the communication module 351 of the client apparatus 31.

Then, the policy manager 220 transmits a base identifier (base ID) to the client apparatus 31 via the communication module 223 (block B12). The base ID is identification information which is uniquely allocated to the client apparatus 31. The base ID may be transmitted in a manner that the base ID is included in the policy data 231A.

Then, the communication module 223 receives temporary index data 363A (second index data) which has been transmitted by the client apparatus 31 (communication module 351) (block B13). The communication module 223 outputs the received temporary index data 363A to the temporary index storage module 226. The temporary index storage module 226 stores the temporary index data 363A in the temporary index storage area 234.

In addition, the communication module 223 receives operation log data 362A (first log data and second log data) which has been transmitted by the client apparatus 31 (block B14). The communication module 223 outputs the received operation log data 362A to the operation log storage module 224. The operation log storage module 224 stores the operation log data 362A to the operation log storage area 233.

Subsequently, the index merge module 227 merges the temporary index data 234A, which is stored in the temporary index storage area 234, into the index data 235A (first index data) stored in the index storage area 235 (block B15).

In addition, the index generator 225 generates index data 235A (fourth index data) corresponding to, among the operation log data 362A received in block B14, operation log data (second log data) which has no associated temporary index data 363A (block B16). Specifically, based on the policy data 231A associated with the client apparatus 31, the index generator 225 detects, among the operation log data 362A received in block B14, the operation log data (second log data not belonging to the first category designated in the policy data 231A) whose associated temporary index data 234A (363A) is absent. Then, the index generator 225 generates index data corresponding to the detected operation log data, and outputs the generated index data to the index merge module 227. The index merge module 227 merges the index data, which has been output by the index generator 225, into the index data 235A stored in the index storage area 235.

Then, in response to the fact that the index data corresponding to the operation log data received from the client apparatus 31 has been stored (merged) in the index storage area 235, the index merge module 227 deletes the temporary index data 234A from the temporary index storage area 234 (block B17).

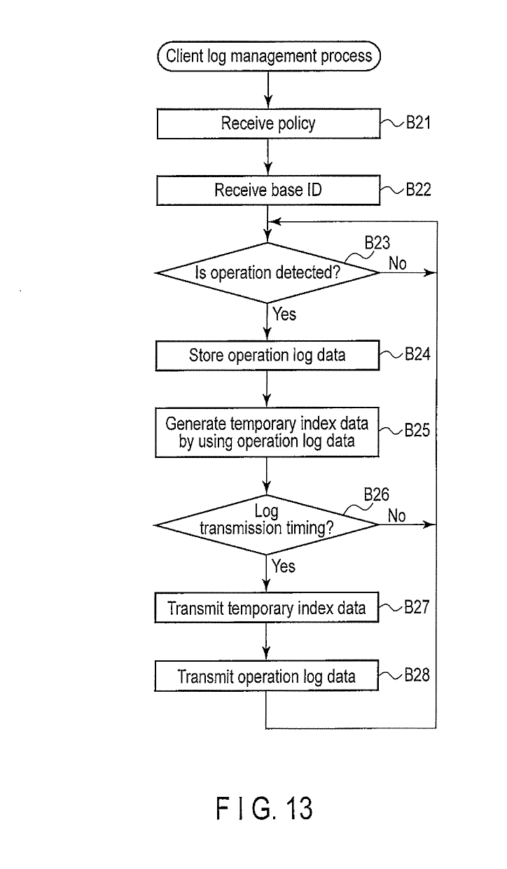

A flowchart of FIG. 13 illustrates an example of the procedure of a log management process by the client apparatus 31.

To start with, the communication module 351 receives the policy data 231A which is associated with the client apparatus 31 and has been transmitted by the server apparatus 21 (communication module 223) (block B21). The communication module 351 outputs the received policy data 231A to the policy storage module 352. The policy storage module 352 stores the policy data 231A, which has been output by the communication module 351, in the policy storage area 361.

Then, the communication module 351 receives the base ID which can uniquely identify the client apparatus 31 (block B22). The communication module 351 outputs the received base ID to the index generator 355.

Subsequently, by monitoring the operating system 34, etc., the monitor module 353 determines whether an operation has been detected (block B23). When no operation has been detected (NO in block B23), the monitor module 353 returns to block 823, and determines once again whether an operation has been detected. On the other hand, when an operation has been detected (YES in block B23), the operation log storage module 354 stores a log (operation log data 362A), which is indicative of the detected operation, in the operation log storage area 362 (block B24). Then, the index generator 355 generates temporary index data 363A (second index data) corresponding to the first log data among the stored operation log data 362A, the first log data belonging to the first category designated in the policy data 361A (block B25).

Thereafter, the communication module 351 determines whether a timing has come to transmit the log to the server apparatus 21 (block B26). For example, the communication module 351 transmits the log to the server apparatus 21 at predetermined time intervals. Thus, when a predetermined period has passed since the previous transmission of the log, the communication module 351 determines that the timing to transmit the log has come. In the meantime, for example, when a predetermined amount of log data has been accumulated in the operation log storage area 362, the communication may determine that the timing to transmit the log has come. When it is not the timing to transmit the log (NO in block B26), the process returns to block B23 to determine once again whether an operation has been detected.

On the other hand, the timing to transmit the log has come (YES in block B26), the communication module 351 transmits the temporary index data 363A, which is stored in the temporary index storage area 363, to the server apparatus 21 (communication module 223) (block B27). The communication module 351 transmits the operation log data 362A, which is stored in the operation log storage area 362, to the server apparatus 21 (block B28). Then, by returning to block B23, the collection of logs of the client apparatus 31 and the transmission of the collected logs to the server apparatus 21 can continuously be executed.

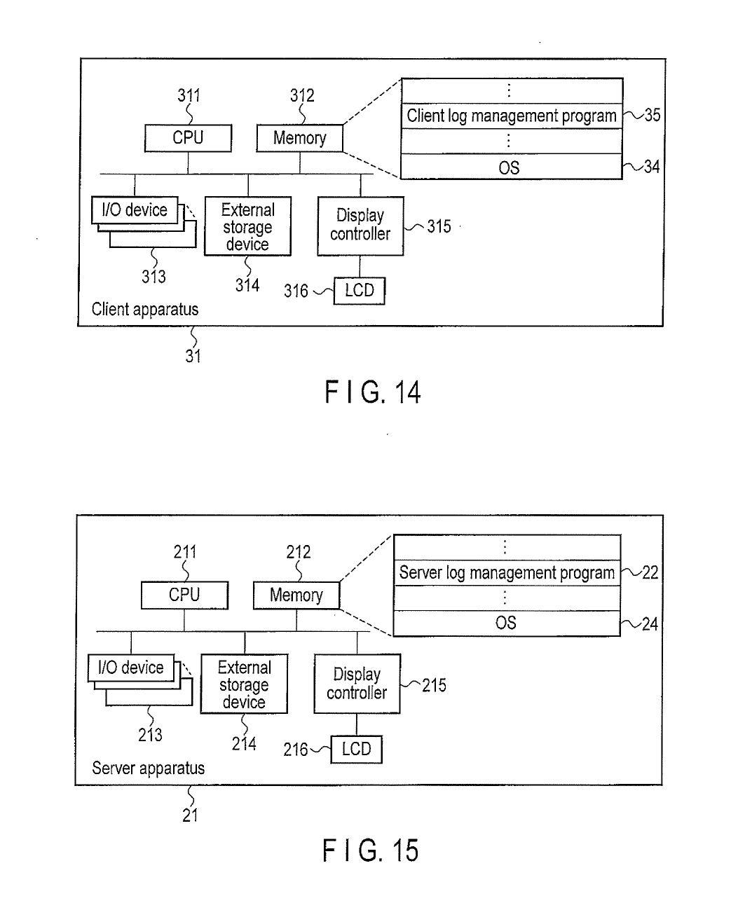

Next, FIG. 14 illustrates an example of the system configuration of the client apparatus 31. The client apparatus 31 includes a central processing unit (CPU) 311, a main memory 312, I/O devices 313, an external storage device 314, a display controller 315, and a liquid crystal display (LCD) 316.

The CPU 311 is a processor which executes various programs. The CPU 311 executes various arithmetic processes and controls the respective components in the client apparatus 31.

The main memory 312 is a main memory for storing an operating system (OS) 34 and various application programs, such as a client log management program 35, which are executed by the CPU 311, and for storing various data. The OS 34 and client log management program 35, for instance, are loaded in the main memory 312.

The I/O devices 313 are various input/output devices for inputting/outputting data to/from the client apparatus 31. The external storage device 314 is a nonvolatile storage device for storing various programs and data. The various programs and data stored in the external storage device 314 are loaded in the main memory 312 in accordance with a request by the respective components in the client apparatus 31. The operation of the client log management program 35, which is loaded in the main memory 312, is as has been described with reference to FIG. 3, etc.

The display controller 315 controls the LCD 316 which is used as a display monitor of the client apparatus 31. A display signal, which is generated by the display controller 315, is sent to the LCD 316. By using the display controller 315 and LCD 316, for example, a screen corresponding to an operation by the user can be displayed.

FIG. 15 illustrates an example of the system configuration of the server apparatus 21. The server apparatus 21 includes a central processing unit (CPU) 211, a main memory 212, I/O devices 213, an external storage device 214, a display controller 215, and a liquid crystal display (LCD) 216.

The CPU 211 is a processor which executes various programs. The CPU 211 executes various arithmetic processes and controls the respective components in the server apparatus 21.

The main memory 212 is a main memory for storing an operating system (OS) 24 and various application programs, such as a server log management program 22, which are executed by the CPU 211, and for storing various data. The OS 24 and server log management program 22, for instance, are loaded in the main memory 212.

The I/O devices 213 are various input/output devices for inputting/outputting data to/from the server apparatus 21. The external storage device 214 is a nonvolatile storage device for storing various programs and data. The various programs and data stored in the external storage device 214 are loaded in the main memory 212 in accordance with a request by the respective components in the server apparatus 21. The operation of the server log management program 22, which is loaded in the main memory 212, is as has been described with reference to FIG. 3, etc.

The display controller 215 controls the LCD 216 which is used as a display monitor of the server apparatus 21. A display signal, which is generated by the display controller 215, is sent to the LCD 216. By using the display controller 215 and LCD 216, for example, a screen corresponding to an operation by the administrator can be displayed.

As has been described above, according to the present embodiment, the time, which is needed until the search of the log data of the client apparatus with use of the index data is enabled, can be shortened. As regards the operation log data belonging to the category designated in the policy data 361A, the temporary index data 363A is generated in the client apparatus 31. Thus, the server apparatus 21 does not need to perform the generation itself of this index data, and it should suffice if the server apparatus 21 merges the temporary index data 363A into the index data 235A. Therefore, the load of processing, which is necessary for the server apparatus 21 to obtain the index data 235A, can be reduced. Thereby, it becomes possible to shorten the time that is needed until the server apparatus 21 is enabled to search the log data 233A, which has been collected by the client apparatus, by using the index data 235A.

All the procedures of the server log management process and client log management process in this embodiment can be executed by software. Thus, the same advantageous effects as with the present embodiment can easily be obtained simply by installing a computer program, which executes the procedures of the server log management process and client log management process, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage configured to store a plurality of log data, and first index data corresponding to the plurality of log data;
a log receiver configured to receive first log data and second index data from a client apparatus connected via a network, the second index data corresponding to the first log data; and
a merge module configured to generate third index data by merging the first index data and the second index data,
wherein the storage is configured to store the plurality of log data, the first log data and the third index data.

2. The information processing apparatus of claim 1, further comprising:
a policy generator configured to generate policy data indicative of a first category to which the first log data belongs, wherein the second index data corresponding to the first log data is generated in the client apparatus; and
a policy transmitter configured to transmit the policy data to the client apparatus,
wherein the log receiver is configured to receive the first log data belonging to the first category, the second index data, and second log data not belonging to the first category.

3. The information processing apparatus of claim 2, further comprising:
an index generator configured to generate fourth index data corresponding to the second log data,
wherein the merge module is configured to generate the third index data by merging the first index data, the second index data and the fourth index data, and
the storage is configured to store the plurality of log data, the first log data, the second log data, and the third index data.

4. The information processing apparatus of claim 2, wherein the first category is a category to which log data with a high frequency of search belongs.

5. The information processing apparatus of claim 2, wherein the first category is a category to which log data with a large data amount belongs.

6. The information processing apparatus of claim 1, wherein the log receiver is configured to receive the first log data, the second index data corresponding to the first log data, and second log data, and
the information processing apparatus further comprises an index generator configured to generate fourth index data corresponding to the second log data.

7. The information processing apparatus of claim 6, wherein the merge module is configured to generate the third index data by merging the first index data, the second index data and the fourth index data, and
the storage is configured to store the plurality of log data, the first log data, the second log data, and the third index data.

8. The information processing apparatus of claim 1, further comprising a retrieval module configured to retrieve log data comprising an input character string, from the plurality of log data and the first log data, by using the third index data.

9. The information processing apparatus of claim 1, wherein the first log data comprises data indicative of a content of an operation in the client apparatus.

10. The information processing apparatus of claim 1, wherein the first index data comprises an entry comprising a first character and an identifier indicative of third log data among the plurality of log data, the third log data comprising the first character, and
the second index data comprises an entry comprising a second character in the first log data and an identifier indicative of the first log data.

11. An information processing apparatus which is connected to a server apparatus via a network, the apparatus comprising:
a policy receiver configured to receive policy data from the server apparatus, wherein the policy data indicates a category to which log data belongs, and index data corresponding to the log data is generated in the information processing apparatus;
a log data generator configured to generate log data indicative of a content of an operation on the information processing apparatus;
an index generator configured to generate index data corresponding to the generated log data when the generated log data belongs to the category; and
a log transmitter configured to transmit the generated log data and the generated index data to the server apparatus.

12. A client management method comprising:
storing a plurality of log data, and first index data corresponding to the plurality of log data;
receiving first log data and second index data from a client apparatus which is connected via a network, the second index data corresponding to the first log data; and
generating third index data by merging the first index data and the second index data,
wherein the storing comprises storing the plurality of log data, the first log data and the third index data.

13. The client management method of claim 12, further comprising:
generating policy data indicative of a first category to which the first log data belongs, wherein the second index data corresponding to the first log data is generated in the client apparatus; and
transmitting the policy data to the client apparatus,
wherein the receiving comprises receiving the first log data belonging to the first category, the second index data, and second log data not belonging to the first category.

14. The client management method of claim 13, further comprising:
generating fourth index data corresponding to the second log data,
wherein the generating the third index data comprises generating the third index data by merging the first index data, the second index data and the fourth index data, and
the storing comprises storing the plurality of log data, the first log data, the second log data, and the third index data.

15. The client management method of claim 13, wherein the first category is a category to which log data with a high frequency of search belongs.

16. The client management method of claim 13, wherein the first category is a category to which log data with a large data amount belongs.

17. The client management method of claim 12, wherein the receiving comprises receiving the first log data, the second index data corresponding to the first log data, and second log data, and
the client management method further comprises generating fourth index data corresponding to the second log data.

18. The client management method of claim 17, wherein the generating the third index data comprises generating the third index data by merging the first index data, the second index data and the fourth index data, and
the storing comprises storing the plurality of log data, the first log data, the second log data, and the third index data.

19. The client management method of claim 12, further comprising retrieving log data comprising an input character string, from the plurality of log data and the first log data, by using the third index data.

20. The client management method of claim 12, wherein the first log data comprises data indicative of a content of an operation in the client apparatus.

21. The client management method of claim 12, wherein the first index data comprises an entry comprising a first character and an identifier indicative of third log data among the plurality of log data, the third log data comprising the first character, and
the second index data comprises an entry comprising a second character in the first log data and an identifier indicative of the first log data.

22. A client management system comprising a server apparatus and a client apparatus which are connected via a network, the client apparatus being configured to:
generate first log data indicative of a content of an operation on the client apparatus;
generate second index data corresponding to the first log data; and
transmit the first log data and the second index data to the server apparatus,
the server apparatus being configured to:
store a plurality of log data, and first index data corresponding to the plurality of log data;
receive the first log data and the second index data from the client apparatus; and
generate third index data by merging the first index data and the second index data, and
the storing comprising storing the plurality of log data, the first log data, and the third index data.

23. The client management system of claim 22, wherein the server apparatus is further configured to:
generate policy data indicative of a first category to which the first log data belongs; and
transmitting the policy data to the client apparatus, and
the receiving comprises receiving the first log data belonging to the first category, the second index data, and second log data not belonging to the first category.

24. The client management system of claim 23, wherein the server apparatus is further configured to:
generate fourth index data corresponding to the second log data,
the generating the third index data comprises generating the third index data by merging the first index data, the second index data and the fourth index data, and
the storing comprises storing the plurality of log data, the first log data, the second log data, and the third index data.

25. The client management system of claim 23, wherein the first category is a category to which log data with a high frequency of search belongs.

26. The client management system of claim 23, wherein the first category is a category to which log data with a large data amount belongs.

27. The client management system of claim 22, wherein the receiving comprises receiving the first log data, the second index data corresponding to the first log data, and second log data, and
the server apparatus is further configured to generate fourth index data corresponding to the second log data.

28. The client management system of claim 27, wherein the generating the third index data comprises generating the third index data by merging the first index data, the second index data and the fourth index data, and
the storing comprises storing the plurality of log data, the first log data, the second log data, and the third index data.

29. The client management system of claim 22, wherein the server apparatus is further configured to retrieve log data comprising an input character string, from the plurality of log data and the first log data, by using the third index data.

30. The client management system of claim 22, wherein the first log data comprises data indicative of a content of an operation in the client apparatus.

31. The client management system of claim 22, wherein the first index data comprises an entry comprising a first character and an identifier indicative of third log data among the plurality of log data, the third log data comprising the first character, and
the second index data comprises an entry comprising a second character in the first log data and an identifier indicative of the first log data.
